(19) United States
(12) Patent Application Publication
(10) Pub. No.: US 2008/0265076 A1
(43) Pub. Date: Oct. 30, 2008

(54) Device for the Storage, Management, & Transportation of Articles Such as Cord, Wire, & Cable

(76) Inventor: John P. Petteys, Amsterdam, NY (US)

Correspondence Address: John P. Petteys, 147 Kettle Rd., Amsterdam, NY, 12010, US

(21) Appl. No.: 12/111,961

(22) Filed: Apr. 29, 2008

Related U.S. Application Data
(60) Provisional application No. 60/914,972, filed on Apr. 30, 2007.

(51) Int. Cl. B65H 75/02; F16M 11/00; A47F 5/08; B65H 29/00

(52) U.S. Cl. 242/118; 248/158; 248/205.1; 221/312 C

(57) ABSTRACT

A new device for the storage, management, & transportation of articles such as cord, wire, cable, and tubing that generally comprises a main housing body having a lid, a multitude of cord, wire, cable, and tubing dispensing openings, a multitude of cord, wire, cable, and tubing retractor devices, and first and second mounting clamps, and which is intended to be mounted or attached to a device such as a medical monitor stand and used to manage a multitude of wires which are commonly referred to as “lead wires” and are used for the medical monitoring of a patient, whereby the user can simply grab the exposed end of the cord, wire, cable, or tubing that is desired, and pull or extract it from the housing to the desired length and then locked into place. When the cord, wire, cable or tubing is no longer needed, the article is simply unlocked and retracted back into the main housing unit, thereby keeping the cords, wires, cables, or tubes stored in an organized and managed environment which can be easily transported or moved.

This application claims the prior filing benefit of provisional patent application No. 60914972 filed on Apr. 30 2007.

### BACKGROUND OF THE INVENTION

### FIELD OF THE INVENTION

This invention relates generally to the field of devices for storing & managing cords or cables. Moreover it pertains specifically to a device for the storing, managing, & transporting of multiple articles including cords, wires, cables, tubes, and leads such as those that are related to equipment within a hospital environment.

### SUMMARY OF THE INVENTION

In view of the limitations now present in the prior art, the present invention provides a new and useful device for the storage, management, & transportation of articles such as cord, wire, & cable, which is simpler in construction, more universally usable and more versatile in operation than known device of this kind.

The purpose of the present invention is to provide a new device for the storing, managing, & transporting of multiple articles including cords, wires, cables, tubes, and leads such as those that are related to equipment within a hospital environment. It is also a purpose of the present invention to provide a new device for the storage, management, & transportation of articles such as cord, wire, & cable that has many novel features not offered by the prior art apparatus that result in a new device for the storage, management, & transportation of articles such as cord, wire, & cable which is not apparent, obvious, or suggested, either directly or indirectly by any of the prior art apparatus.

The present invention is a housing unit that incorporates retractor mechanisms that allow a user to organize, manage, and dispense a multitude of cord, wire, cable, or tubing articles. In the preferred embodiment, the device is intended to be used to manage a multitude of wires which are commonly referred to as “lead wires” and are used for the medical monitoring of a patient. These leads consist of an electrocardiogram (EKG), (SPO2) wire that measures oxygen saturation, (CO) wire which measures cardiac output, and a blood pressure cuff. The invention disclosed herein will allow a user to simply grab the exposed end of the cord, wire, cable, or tubing that is desired, and pull or extract it from the housing. Once the desired length is extracted from the housing, the cord, wire, cable or tube is then locked into place. When the cord, wire, cable or tubing is no longer needed, the article is simply unlocked and retracted back into the main housing unit, thereby keeping the cords, wires, cables, or tubes stored in an organized and managed environment which can be easily transported or moved.

### SUMMARY OF THE INVENTION (continued)

The present invention in the preferred embodiment generally comprises a main housing body having a lid, a multitude of cord, wire, cable, and tubing dispensing openings, a multitude of cord, wire, cable, and tubing retractor devices, and first and second mounting clamps, whereby the main housing body consists of an main body component and a lid component, whereby the lid and the main body component are pivotally connected at the top center of each component. The main body component and the lid component are each formed from two smoothly interconnected shapes which are of a single embodiment and are molded from a single sheet of plastic or cast from a single mold shape. The lid is represented as a continuation of the main body component with the assemblage creating a main body housing which appears to be a single housing unit. The main body housing components, in the preferred embodiment have rounded corners, thereby creating a smooth non- obtrusive housing, minimizing contact with or damage done by or to the housing during use and transport. The multitude of retractor devices are mounted to the interior bottom region of the main body component and are aligned to allow for an array of cords, wires, cables, or tubes to be dispensed in a side by side manner, with the multitude of cord, wire, cable, and tubing dispensing openings being disposed at the bottom front region of the main body component.

The dispensing openings allow for the cord, wire, cable, or tube articles to be fed through the openings, extended, and retracted back into the openings, leaving only the end of the article outside the opening for access and use. Each of the openings will be labeled to identify each cord, wire, cable, or tubing article which is being dispensed. Further, each of the cord, wire, cable, or tube articles being managed will exit an opening in the back of the main body component and plug into a corresponding piece of equipment such as a medical monitor or other device.

The main housing body also contains a multitude of fastening clamps or mounting brackets, which in the preferred embodiment is two, molded or built into the main housing body and being disposed in a variety of locations, with the preferred embodiment having a first clamp which is dispose at the central bottom region of the back of the main

### SUMMARY OF THE INVENTION (continued)

housing body, also having a second clamp disposed at the central top region of the lid portion of the main housing body, whereby the attachments will allow for mounting or attaching the main body housing to a variety of different articles including but not limited in use to, the cylindrical vertical shaft of a transport or bedside monitor, a medical equipment transport rack or other device not referred to herein which can receive or accept the device and performs the same function disclosed herein and is to be considered apparent and obvious to the disclosure contained herein.

The present invention in the preferred embodiment is intended to be made of a durable hard plastic which can be heat formed or injection molded to the desired shape, which will result in a durable lightweight housing body that can withstand rigorous sanitizing and cleaning, and which can be easily lifted and handled for attachment and detachment to and from equipment. The invention in alternate embodiments may also be manufactured using a variety of other suitable materials including but not limited in use to, metals, such as aluminum, tin, stainless steel, and other materials not referred to herein which perform the same function and are to be considered apparent and obvious to the disclosure contained herein.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTIVES OF THE INVENTION

Accordingly several advantages and objects of the present invention are:

A principal objective of the present invention is to provide a Device for the Storage, Management, & Transportation of Articles Such as Cord, Wire, & Cable that will overcome the deficiencies of the prior art devices.

An objective of the present invention is to provide a Device for the Storage, Management, & Transportation of Articles Such as Cord, Wire, & Cable that can manage and organize a number of different cord, wire, cable, or tube articles.

Another objective of the present invention is to provide a Device for the Storage, Management, & Transportation of Articles Such as Cord, Wire, & Cable that allows a user to easily locate and grab the end of the desired cord, wire, cable, or tube article.

Another objective of the present invention is to provide a Device for the Storage, Management, & Transportation of Articles Such as Cord, Wire, & Cable that provides a clean non-hazardous environment in which to store the articles, preventing the articles from becoming damaged or soiled when not in use.

Another objective of the present invention is to provide a Device for the Storage, Management, & Transportation of Articles Such as Cord, Wire, & Cable that will prevent the cord or wire articles from becoming tangled when not in use.

Another objective of the present invention is to provide a Device for the Storage, Management, & Transportation of Articles Such as Cord, Wire, & Cable that decreases the incidence of injury or damage caused by tripping or falling over unmanaged tangled wires.

Another objective of the present invention is to provide a Device for the Storage, Management, & Transportation of Articles Such as Cord, Wire, & Cable that allows for the organized and managed transport of equipment and wires attached thereto.

### OBJECTIVES OF THE INVENTION (continued)

Another objective of the present invention is to provide a Device for the Storage, Management, & Transportation of Articles Such as Cord, Wire, & Cable that improves the clinician's ability to treat a patient in a safe efficient manner.

Another objective of the present invention is to provide a Device for the Storage, Management, & Transportation of Articles Such as Cord, Wire, & Cable that can be offered in a variety of shapes and sizes to suit a variety of application needs.

Another objective of the present invention is to provide a Device for the Storage, Management, & Transportation of Articles Such as Cord, Wire, & Cable that can be use for the test and treatment of anterior, posterior and horizontal canalithiasis.

It is intended that any other advantages and objectives of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention.

FIG. 1. is a front view of a device for the storage, management, & transportation of articles such as cord, wire, & cable according to the present invention, illustrating the invention(111) in the closed ready to use state with a plurality of cables or wires(119) protruding from the cable dispensing openings(113).

FIG. 2. is a side view of a device for the storage, management, & transportation of articles such as cord, wire, & cable according to the present invention, illustrating the invention(111) in the closed ready to use state with a plurality of cables or wires(119) protruding from the cable dispensing openings(113), and further showing the rear cable opening(120) as well as the pole mounting clamps(115) at the lower rear position of the main body base(116) and the optional clamp position on top of the lid(117), also showing the air vents (121).

FIG. 3. is a front sectional view of a device for the storage, management, & transportation of articles such as cord, wire, & cable according to the present invention(111), illustrating the multiple cord or cable retractor devices(114) in the installed position within the main body base component(116).

FIG.4. is a side sectional view of a device for the storage, management, & transportation of articles such as cord, wire, & cable according to the present invention, illustrating the lid component(117) in the closed position, the hinge(118), the rear cable opening(120), the pole clamp(115), and also showing the cord or cable retractor devices(114) in the installed position.

FIG. 5. is another side sectional view of a device for the storage, management, & transportation of articles such as cord, wire, & cable according to the present invention, illustrating the lid component(117) in the opened position, the hinge(118), the rear cable opening(120), the pole clamp(115), and also showing the cord or cable retractor devices(114) in the installed position within the main body base component(116), and also in the removed position(114a).

BRIEF DESCRIPTION OF THE DRAWINGS (continued

FIG. 6. is plan view of a device for the storage, management, & transportation of articles such as cord, wire, & cable according to the present invention, illustrating the lid component(117) in the opened position, the hinge(118), and the rear cable opening(120).

FIG. 7. is a perspective front view of a device for the storage, management, & transportation of articles such as cord, wire, & cable according to the present invention, illustrating the lid component(117) in the closed position, and the front cable dispensing openings(113) from which a plurality of cables and wires(119) are protruding

FIG. 8. is a perspective back view of a device for the storage, management, & transportation of articles such as cord, wire, & cable according to the present invention, illustrating the lid component(117) in the closed position, the hinge(118), and the rear cable opening(120) from which a plurality of cables and wires(119) are protruding.

FIG. 9. is another perspective front view of a device for the storage, management, & transportation of articles such as cord, wire, & cable according to the present invention, illustrating the invention(111) mounted to a portable medical stand pole(122), with the lid component(117) in the closed position, the hinge(118), and the front cable dispensing openings(113) from which a plurality of cables and wires(119) are protruding

### DETAILED DESCRIPTION OF THE INVENTION

Referring now, descriptively to the drawings, the attached figures illustrate a Device for the Storage, Management, & Transportation of Articles Such as Cord, Wire, & Cable.

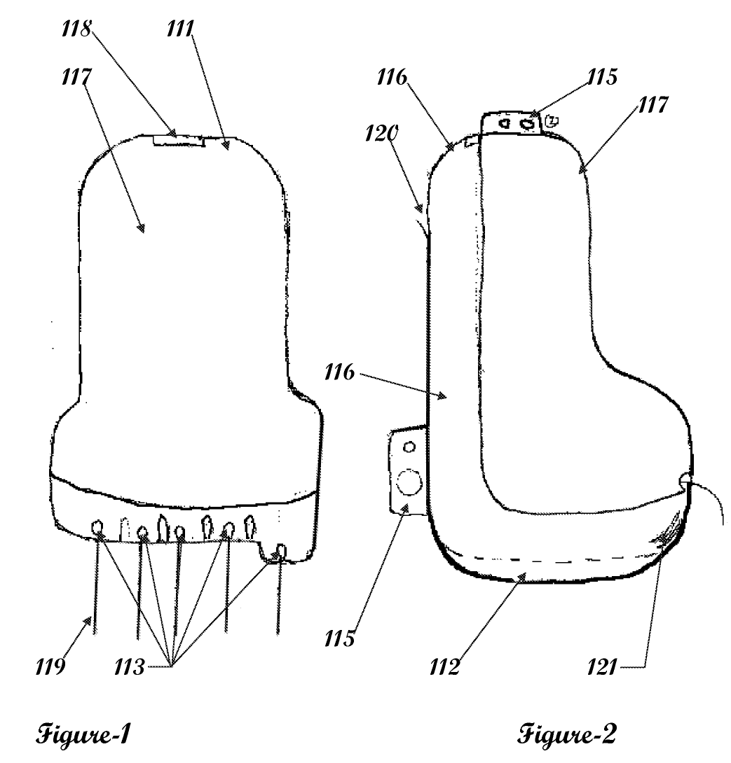

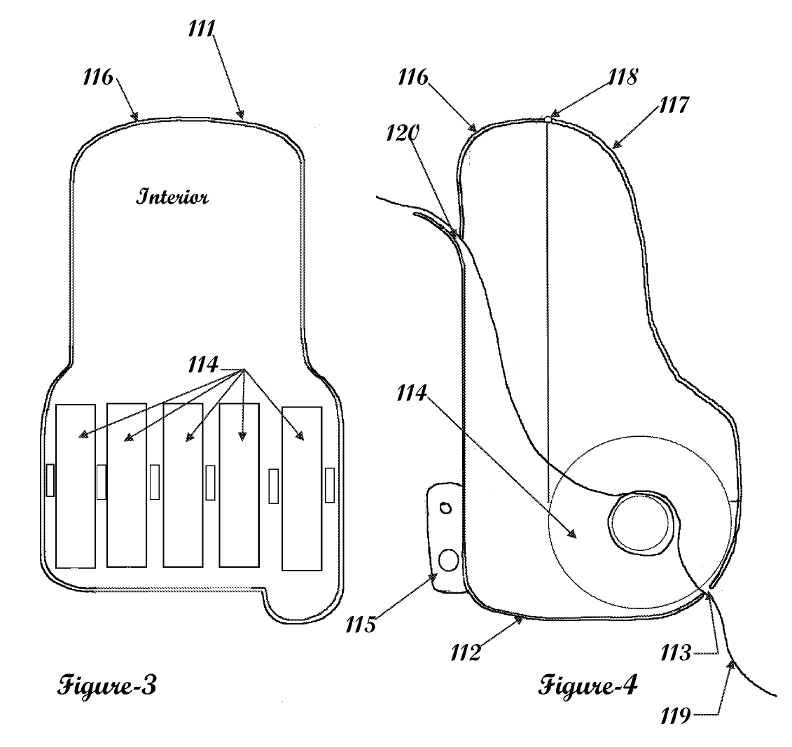

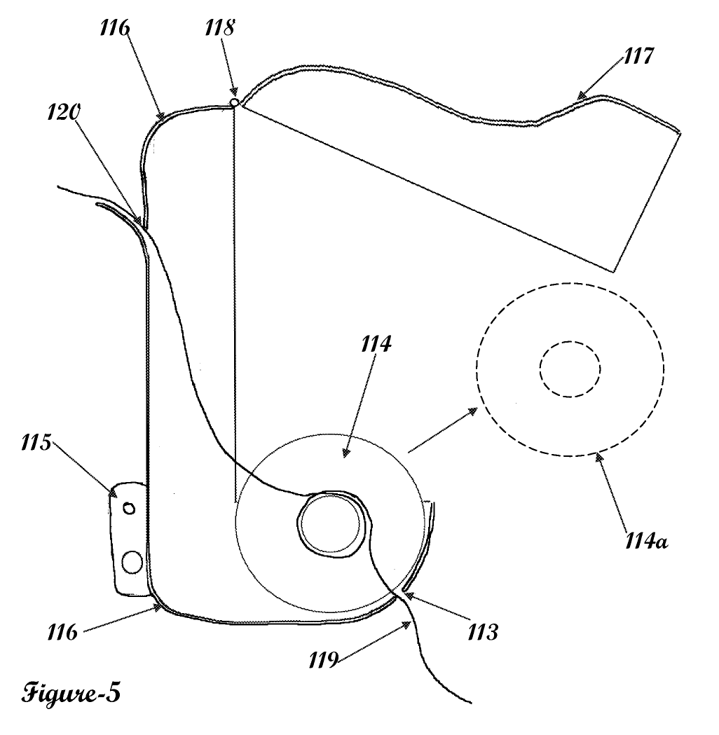

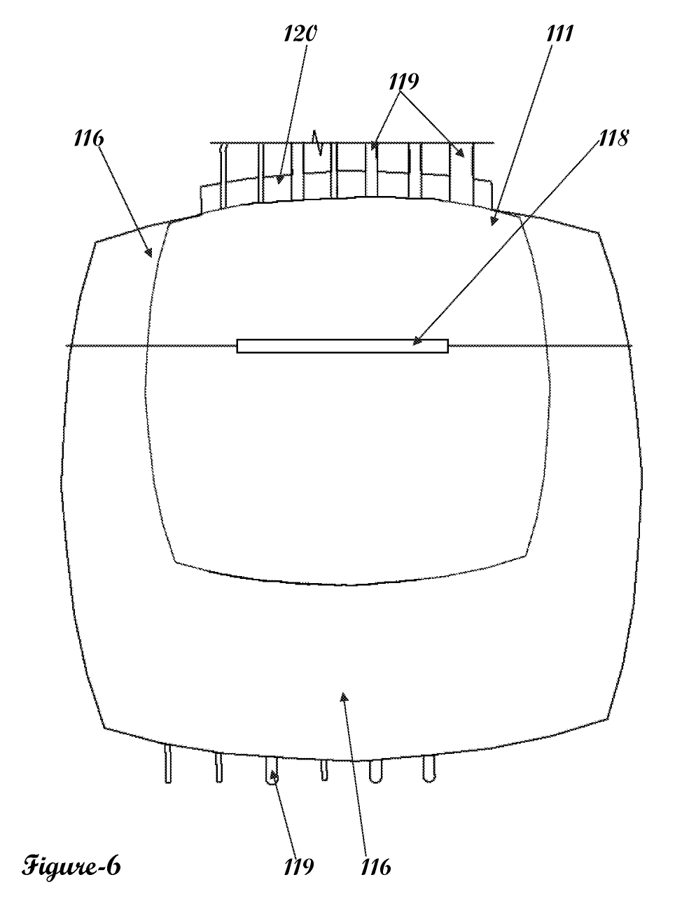

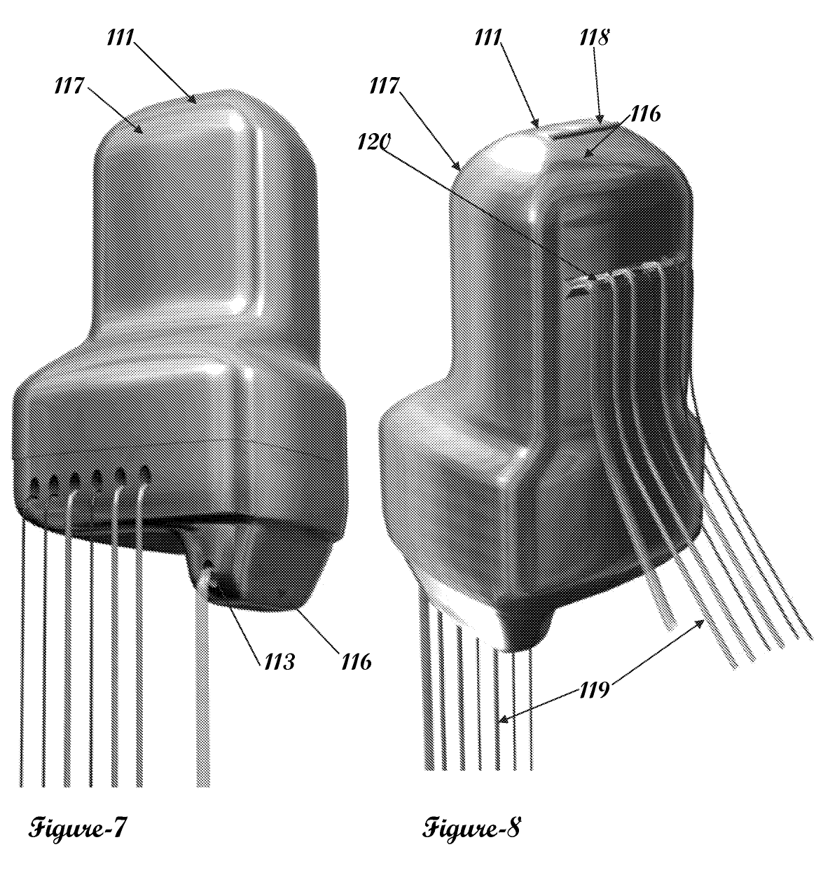

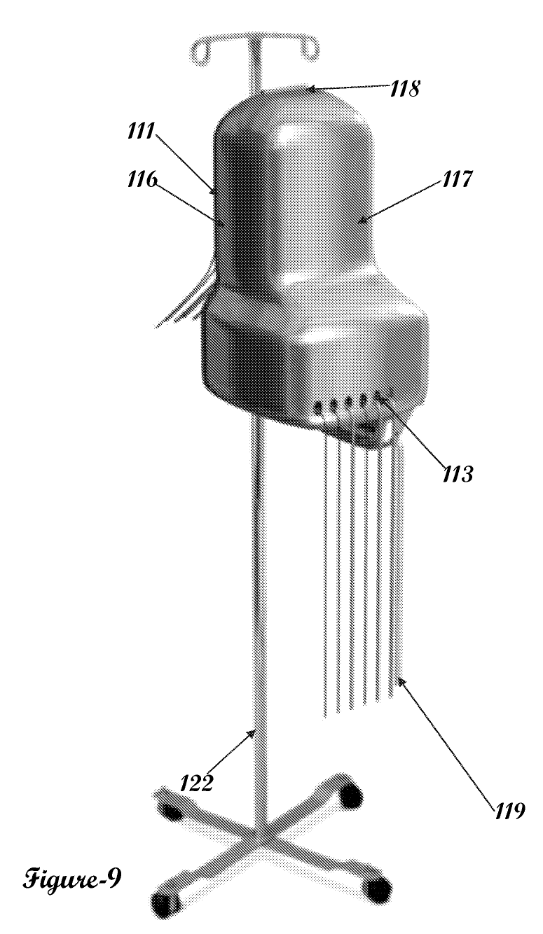

FIG. 1 illustrates the present invention(111) in the assembled state comprising a main housing body(112), a multitude of cord, wire, cable, and tubing dispensing openings(113), a multitude of cord, wire, cable, and tubing retractor devices(114), pole(122) mounting clamps(115), and optional wall mounting hardware and openings, whereby the main housing body(112) consists of a main body base component(116) and a lid component(117), whereby and the main body base component (116) and the lid component(117) are pivotally connected at the top center of each component by means of a hinge device(118). The main body base component(116) and the lid component(117) are each formed from two smoothly interconnected shapes which are of a single embodiment and are molded from a single sheet of plastic or cast from a single mold shape. The lid component(117) is represented as a continuation of the main body base component(116) with the assemblage creating a main body housing(112) which appears to be a single housing unit. The main body housing components, in the preferred embodiment have rounded comers, thereby creating a smooth non-obtrusive housing, minimizing contact with or damage done by or to the housing during use and transport. The multitude of retractor devices(114) are mounted to the interior bottom region of the main body base component(116) and are aligned to allow for an array of cords, wires, cables, or tubes(119) to be dispensed in a side by side manner, through the multitude of cord, wire, cable, and tubing dispensing openings(113) disposed at the bottom front region of the main body base component(116) as well as out through a rear opening(120) disposed at the back surface of the main body base component(116) which further contains a plurality of air vent openings(121) disposed at the lateral lower sides of the main body base component(116).

I claim:

1. A cord, wire, & cable storage, management, & transportation apparatus comprising a main housing body having a main body base component, a hinged main body lid component, a plurality of cord, wire, cable, and tubing dispensing openings, a plurality of cord, wire, cable, and tubing retractor/dispensing devices, and mounting clamps.

2. The apparatus of claim 1 wherein the mounting clamps allow for attachment to the vertical pole portion of a portable medical stand.

3. The apparatus of claim 1 wherein the mounting clamps allow for vertically adjustable attachment to the vertical pole portion of a portable medical stand.

4. The apparatus of claim 1 wherein the mounting clamps allow for attachment to a vertical surface such as a wall or cabinet.

5. The apparatus of claim 1 wherein the hinged lid component is detachable.

6. The apparatus of claim 1 wherein the plurality of cord, wire, cable, and tubing retractor/dispensing devices are removable and replaceable.

7. The apparatus of claim 1 wherein main body base component embodies air vent openings.

8. A two piece dispenser for cord, wire, cable, and tubing that will allow the user to dispense a unique specific amount of cord, wire, cable, or tubing while securely storing the remaining portion of cord, wire, cable, or tubing in an organized manner.
